(19) United States
(12) Patent Application Publication
(10) Pub. No.: US 2011/0057409 A1
(43) Pub. Date: Mar. 10, 2011

(54) Dual Load Path Suspension Assembly with Auxiliary Roll Stiffness

(75) Inventor: Gregory Kevin Leeder, Fort Wayne, IN (US)

(73) Assignee: International Truck Intellectual Property Company, LLC, Warrenville, IL (US)

(21) Appl. No.: 12/555,868

(22) Filed: Sep. 9, 2009

(51) Int. Cl. B60G 11/04

(52) U.S. Cl. 280/124.175

(57) ABSTRACT

A suspension assembly for a vehicle has at least two leaf spring assemblies providing at least two load paths. The leaf springs are vertically separated and mount to a shackle assembly which is mounted to the chassis. The shackle assembly has at least two shackles and may have a load transfer assembly. The leaf springs also attach to a spring hanger opposite the shackle assembly. The load transfer assembly has inner and outer load transfer plates to which the leaf springs and the shackles fasten to form a four-bar linkage.

### FIELD OF THE INVENTION

The present disclosure relates to a suspension assembly with leaf springs for a vehicle with a suspension and an axle.

### BACKGROUND

A Hotchkiss-type leaf spring suspension assembly is simple and effective but has limitations. One limitation is the tradeoff between roll stiffness and vertical stiffness for a comfortable ride and responsive vehicle handling. Roll stiffness of the suspension assembly relates to the vertical stiffness of the leaf springs and their lateral spacing by the relationship of the vertical stiffness multiplied by the square of the lateral spacing. Vertical stiffness, for example, may be chosen for a comfortable ride, such as providing a desired suspension natural frequency, while lateral spacing is largely dictated by available space and structural design considerations of transmitting suspension loads to the vehicle frame. The choice may result in roll stiffness lower than ideal for vehicle handling. Conversely, springs selected to meet particular roll stiffness may provide a vertical stiffness and natural frequency higher than ideal for a comfortable ride.

Another limitation of the Hotchkiss-type leaf spring suspension relates to the axle location. The axle location in the sense of caster angle is governed by second-order vertical bending stiffness of the leaf springs, such as the leaf spring deflection mode of a horizontal S-shape with the axle at the center of the “S”. While this is a concern primarily under braking conditions, it is also a concern under conditions of driving torque (for the case of a driven axle) and a longitudinal impact at the tire (such as a bump or pothole). Also, the reaction of braking forces and torques between the axle and the chassis/frame through the mechanism of second-order leaf spring vertical bending imposes significant constraints on the design relating to “anti-dive”, “anti-lift”, or “anti-squat” geometry.

A third limitation is that some of the spring leaves are not fully used for lateral stiffness. Typical heavy-duty Hotchkiss-type suspensions have leaf springs with multiple leaves. Generally, only one of the leaves has features at either end for mounting to the frame or body, such as a formed eye with an elastomeric bushing. While the remaining leaves are not directly connected to the frame-mounted leaf at the eye, they can attach to the mounted leaf at the central axle. The remaining leaves, therefore, have a lateral-longitudinal sliding relationship with frame ends of the frame-mounted leaf, governed by normal forces and friction coefficients. The remaining leaves contribute little to lateral stiffness and are inefficient relative to their weight.

Some leaf springs are designed with a second leaf extended and wrapping around the eye formed with the first, frame-mounted leaf. This “military wrapper” design is primarily a safety measure for retaining the axle in case of the mechanical failure of the first leaf. The second leaf still has a sliding relationship with the first leaf and the lateral stiffness drawbacks related to the sliding relationship.

A fourth limitation is the friction inherent in the sliding relationships between multiple spring leaves. As the suspension articulates, longitudinal (and/or lateral) force builds up at the interface between adjacent leaves until friction is overcome, then the leaves break free in a “stick-slip” manner. This cycle of force building up, abruptly releasing when an interface breaks free, and then abruptly returning to the force build-up phase when the interface “seizes” again, causes suspension hysteresis. In suspension hysteresis, the force is not consistently or smoothly related to displacement. Particularly in the case of small motions, this friction effect can significantly increase the effective stiffness of the entire suspension assembly, which is detrimental to vehicle ride quality and handling precision. To reduce hysteresis, additional components are sometimes added between spring leaves, such as low-friction polymeric liners.

Therefore, there is a need to develop a suspension system that improves roll stiffness without greatly increasing vertical stiffness and without relying upon additional devices such as anti-sway bars, in order to better optimize vehicle handling and ride comfort. There is an additional need for a suspension system with improved handling characteristics resulting from increased lateral stiffness and reduced castor angle change during articulation, braking torque, and driving torque, in order to improve vehicle handling precision. There is a further need to produce a suspension assembly with reduced friction and hysteresis, to improve vehicle ride comfort and handling precision. Finally, there is a need to add redundant elements to the suspension assembly to increase safety.

### SUMMARY

Accordingly, a suspension assembly is provided with a vehicle with a chassis and an axle. The suspension assembly has upper and lower leaf springs that are spaced apart from each other, a shackle assembly and a shackle hanger attaching to the chassis. The shackle assembly has first and second shackles that pivotally attach to the shackle hanger. The first ends of each of the leaf springs pivotally fasten to the shackle assembly spaced apart from each other. The second ends of each of the leaf springs pivotally fasten to a spring hanger spaced apart from each other.

The upper and lower leaf springs combined with the spaced-apart first and second shackles provide dual load paths. These load paths are supported by a load transfer assembly, shackle assembly, and spring hanger and contribute to auxiliary roll stiffness, to lateral stiffness, better control of axle caster angle, improved management of braking and driving torques, and improved safety by increased redundancy. Additionally, these linkages produce torque reactions between the axle and the frame, for improved anti-dive, anti-lift, and anti-squat suspension behavior relative to braking and driving torques.

The inner and outer load transfer plates maintain alignment with each other by means of the spring and shackle fasteners clamping the pivot bushing inner metal columns at four locations. The inner and outer load transfer plates transmit force and torque between the upper and lower leaf springs and the first and second shackles. Because the load transfer assembly is pivotally fastened to the two nearly vertically-oriented shackles and to the two nearly horizontally-oriented leaf springs, suspension articulation causes rotations about the laterally-oriented pivot axes only. The load transfer assembly can provide very high stiffness in regards to rotation about longitudinal and vertical axes and in regards to translation about the lateral axis.

The suspension assembly exhibits a roll center intermediate between the upper and lower leaf springs, such that suspension articulation in roll introduces a small amount of first-order lateral bending in the upper leaf spring and an approximately equal-but-opposite amount of lateral bending in the lower leaf spring. This opposed lateral bending of upper and lower leaf springs generates opposed lateral forces that are coupled by the vertical offset between the leaf springs to produce a restoring moment that resists vehicle roll displacement. The suspension assembly, therefore, provides an additional mechanism to furnish auxiliary roll stiffness while adding little extra mass compared to traditional leaf spring suspensions.

The vertical offset between the upper and lower leaf springs can adjust the auxiliary roll stiffness of the suspension assembly, as the restoring moment is directly proportional to the square of the vertical offsets at the front and rear mounting points of the upper and lower leaf springs multiplied by the lateral stiffness of the leaf springs. This mechanism resists vehicle roll equally on both the left and right sides of the suspension. This auxiliary roll stiffness mechanism operates in addition to the normal roll stiffness resulting from the vertical stiffness of the springs and their lateral spacing. The auxiliary roll stiffness mechanism can affect suspension assembly roll stiffness independently from vertical stiffness, decoupling the customary relationship between roll stiffness and vertical stiffness inherent in traditional leaf spring suspensions and removing a significant constraint from the suspension design process.

The suspension assembly provides additional load paths to increase lateral stiffness by replacing sliding joints with friction reducing joints that engage leaf springs which would otherwise make little contribution to lateral stiffness in traditional leaf spring suspensions. Lateral stiffness may increase by a factor approaching two times normal lateral stiffness simply by incorporating the lower leaf spring into the lateral load path, when compared to traditional leaf spring suspensions with a sliding connection between the first and second spring leaves.

The suspension assembly significantly improves axle location in the sense of reduced caster angle variation, under conditions of braking torque, driving torque, and longitudinal tire inputs. By incorporating dual load paths and effective four-bar linkages, braking torque, driving torque, and longitudinal forces are transmitted through the four-bar linkages as tension and compression force pairs to the vehicle chassis. In contrast, in a traditional leaf spring suspension, such torques and forces cause rotational wind-up of the leaf spring as seen in the side view; this allows the caster angle of the axle to change, altering steering geometry with some detriment to steering feel and directional stability. This suspension assembly improves axle location in the sense of reduced caster angle variation, under conditions of braking torque, driving torque, and longitudinal force inputs.

The suspension assembly provides dual load paths and four-bar linkages that allow for control of suspension anti-dive, anti-lift, and anti-squat characteristics. Anti-dive, anti-lift, and anti-squat behaviors all involve the reaction of braking or driving torques from the axle through the suspension to the vehicle frame. The angles of individual links and their moment-arm distances from the axle govern the magnitudes and directions of the forces developed in the links, and reactions at the frame, due to the braking or driving torques. Adjustment of linkage geometry allows the braking or driving torque reactions to be controlled to achieve desired anti-dive, anti-lift, or anti-squat characteristics. The ability to adjust these characteristics removes an intrinsic design constraint of traditional leaf spring suspensions, thus allowing suspension performance to be better optimized.

The suspension assembly reduces suspension friction by replacing sliding joints with friction reducing joints, such as bushing- or bearing-type joints, providing better ride comfort and handling precision. It also provides greater redundancy in the connection of the axle to the chassis compared to the traditional leaf spring suspension and “military wrappers” to increase the safety margin in the event of a leaf spring mechanical failure.

As described above, the Dual Load Path Suspension Assembly and a vehicle made with this system provide a number of advantages, some of which have been described above and others of which are inherent in the invention. Also, modifications may be proposed to the Dual Load Path Suspension Assembly or a vehicle made with this system without departing from the teachings herein. Additional effects, features and advantages will be apparent in the written description that follows.

### BRIEF DESCRIPTION OF THE DRAWINGS

The novel features believed characteristic are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 is a side plan view of one of the embodiments of the suspension assembly;

FIG. 2 is a sectional view along line A-A′ of FIG. 1 of the shackle assembly;

FIG. 3 is a close up sectional view of FIG. 1 of the shackle assembly using a bushing;

FIG. 4 is a close up sectional view of FIG. 1 of the shackle assembly using a bearing;

FIG. 5 is a side plan view of one of the embodiments of the suspension assembly;

FIG. 6 is a partial bottom view of one of the embodiments of the suspension assembly;

FIG. 7 is a side plan view of one of the embodiments of the suspension assembly;

FIG. 8 is a side plan view of one of the embodiments of the suspension assembly;

FIG. 9 is a side plan view of one of the embodiments of the suspension assembly; and

FIG. 10 is a side plan view of one of the embodiments of the suspension assembly.

### DETAILED DESCRIPTION

Turning to the Figures where like reference numerals refer to like structures, a vehicle, such as a medium or heavy duty truck or school bus, trailer, agricultural implement, construction equipment, and the like, has a suspension assembly 10 mounted to the vehicle's chassis 12. The suspension assembly 10 engages an axle 14. The vehicle can have additional suspension assemblies, for example a second suspension assembly 11 mounted to the other side of the chassis 12 lateral to suspension assembly 10.

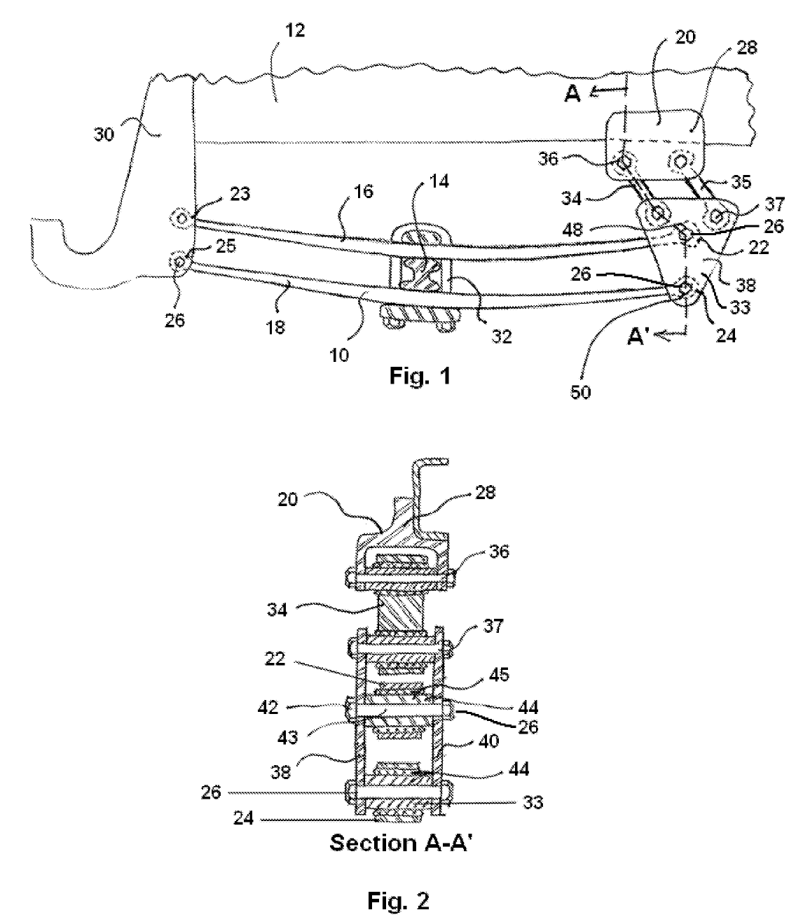

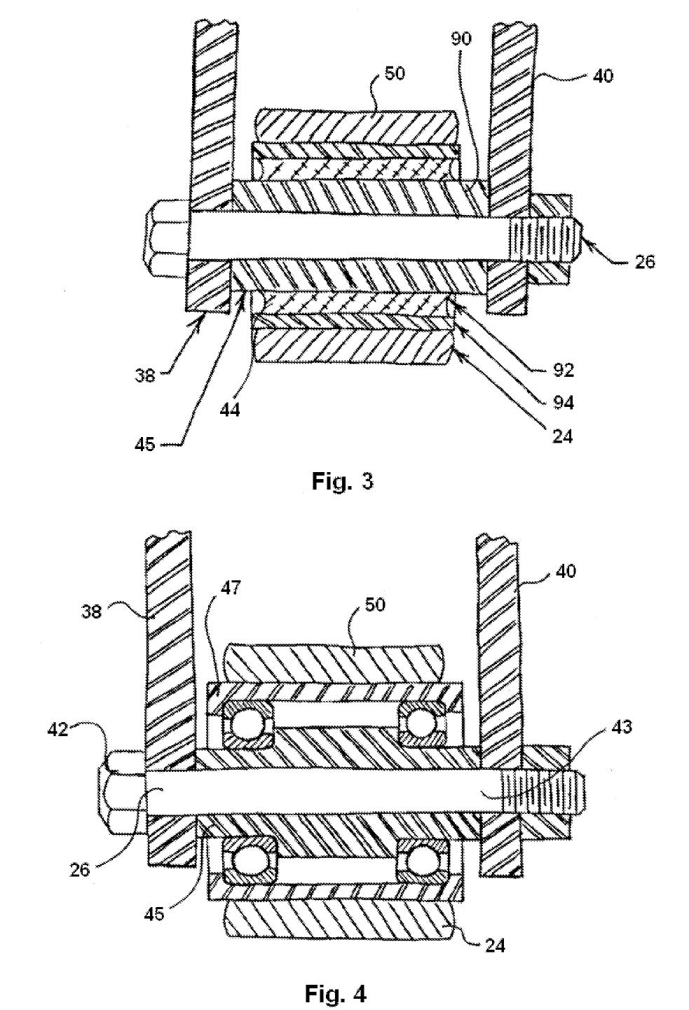

Turning to FIGS. 1-4 and 9-10, the suspension assembly 10 engages the axle 14 at about the center of the suspension assembly 10, although other locations can be used. The suspension assembly 10 has an upper leaf spring 16 and a lower leaf spring 18 located in a spaced apart relation and each pivotally fasten to a shackle assembly 20. The upper leaf spring 16 has an opposite first upper spring end 22 and a second upper spring end 23, and the lower leaf spring 18 has an opposite first lower spring end 24 and a second lower spring end 25. The first upper spring end 22 and first lower spring end 24 each pivotally fasten to the shackle assembly 20 with spring fasteners 26 passing through an upper spring eye 48 and a lower spring eye 50 respectively. The second upper spring end 23 and second lower spring end 25 each pivotally fasten with spring fasteners 26 to a first spring hanger 30 attached to the chassis 12. Alternately, the second upper spring end 23 or second lower spring end 25, or both, may slidably engage the first spring hanger 30 attached to the chassis in a vari-rate type of arrangement (not shown), requiring an additional locating link (not shown) between the axle 14 and the first spring hanger 30 if both the second upper spring end 23 and the second lower spring end 25 are slidably engaged to the first spring hanger 30. Also, the first upper spring end 22 or first lower spring end 24, or both, may slidably engage the shackle assembly 20 in a vari-rate type of arrangement (not shown), requiring an additional locating link (not shown) between the axle 14 and the shackle assembly 20 if both the first upper spring end 22 and the first lower spring end 24 are slidably engaged to the shackle assembly 20.

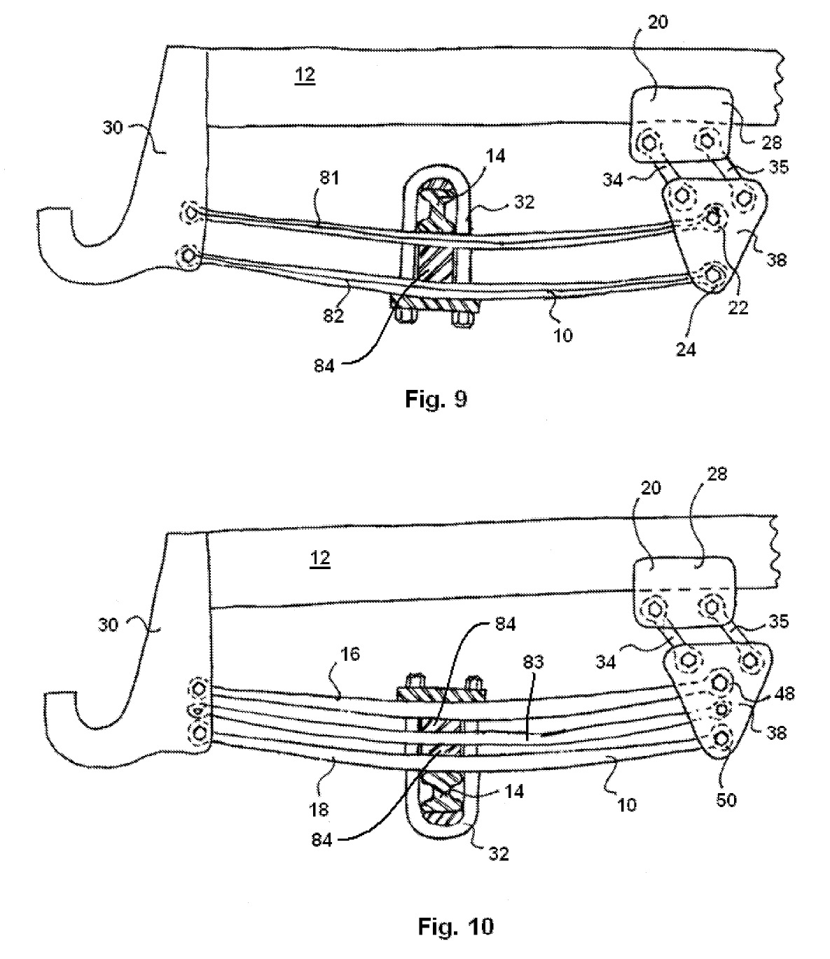

The axle 14 is located between the upper leaf spring 16 and lower leaf spring 18. Both upper leaf spring 16 and lower leaf spring 18 connect to the axle 14 using a U bolt 32 or other suitable mechanical fastener(s). A spacer block or bracket (not shown) may be used between the axle 14 and the upper leaf spring 16, or between the axle 14 and the lower leaf spring 18, or in both locations, to provide adequate separation distance between the springs and control the relative position of the axle 14. Alternatively, the axle 14 can be located above (FIG. 9) or below (FIG. 10) the suspension assembly 10, and spacer blocks 49 or brackets may be used above the upper leaf spring 16 or below the lower leaf spring 18, as well as between the upper leaf spring 16 and the lower leaf spring 18, to adjust the relative positions of the axle 14 to springs 16 and 18.

The shackle assembly 20 has a shackle hanger 28 mounted to the chassis 12. First shackle 34 and second shackle 35 are spaced apart from each other and pivotally fasten to the shackle hanger 28 using shackle fasteners 36. The first shackle 34 and second shackle 35 in this embodiment are compression shackles with the second shackle 35 behind the first shackle 34. A load transfer assembly 33 of the shackle assembly 20 pivotally fastens to first shackle 34 and second shackle 35. The load transfer assembly 33 has substantially parallel first load transfer plate 38 and second load transfer plate 40, having shackle fasteners 37 passing through first load transfer plate 38, second load transfer plate 40, and through first shackle 34 or second shackle 35. The load transfer assembly 33 also has spring fasteners 26 passing though first load transfer plate 38, second load transfer plate 40, and through upper spring eye 48 or lower spring eye 50. The first load transfer plate 38 and second load transfer plate 40 may be polygonal, and may further be triangular.

The first load transfer plate 38 and second load transfer plates 40 may also have additional structures, such as holes, sculpted outer profiles, flanges, reinforcing ribs, and the like, for improved weight and stiffness. A friction reducing device 45, such as a bushing 44, sleeve, bearing 47, roller bearing, ball bearing, tapered roller bearing, or equivalent device, may surround the spring fasteners 26, shackle fastener 36, or shackle fastener 37. The bushing 44, for example, has a bushing inner metal sleeve 90, an elastomeric intermediate material 92 surrounding the bushing inner metal sleeve 90, and a bushing outer metal sleeve 94, all located within the leaf spring eye 50, the leaf spring eye 48, or the end of shackles 34 or 35, and located by the fastener 26 or 37.

Side-view linkages can form between the suspension system 10, the axle 14 and the chassis 12. A side-view linkage can form between the load transfer assembly 33, the upper leaf spring 16 and lower leaf spring 18 and the axle 14 as a quasi-four-bar linkage. The axle 14, the upper leaf spring 16, the first spring hanger 30, and the lower leaf spring 18 can also combine to form a quasi-four-bar linkage. Another side-view linkage can form between the load transfer assembly 33, the first shackle 34 and second shackle 35, and the shackle hanger 28 as a four-bar linkage.

In this disclosure, a quasi-four-bar linkage is similar in function to a conventional four-bar linkage. The degrees of freedom conventionally provided by two adjacent revolute joints, however, are provided by the vertical bending of the two leaf springs 16 and 18. These quasi-four-bar linkages can be thought of as partially-flexible quadrilaterals, essentially rigid at the axle 14, with the leaf springs 16 and 18 gradually becoming less rigid at the first spring hanger 30 and load transfer assembly 33 connections. The first spring hanger 30 and load transfer assembly 33 maintain the distance between the upper and lower leaf spring connections while the suspension articulates.

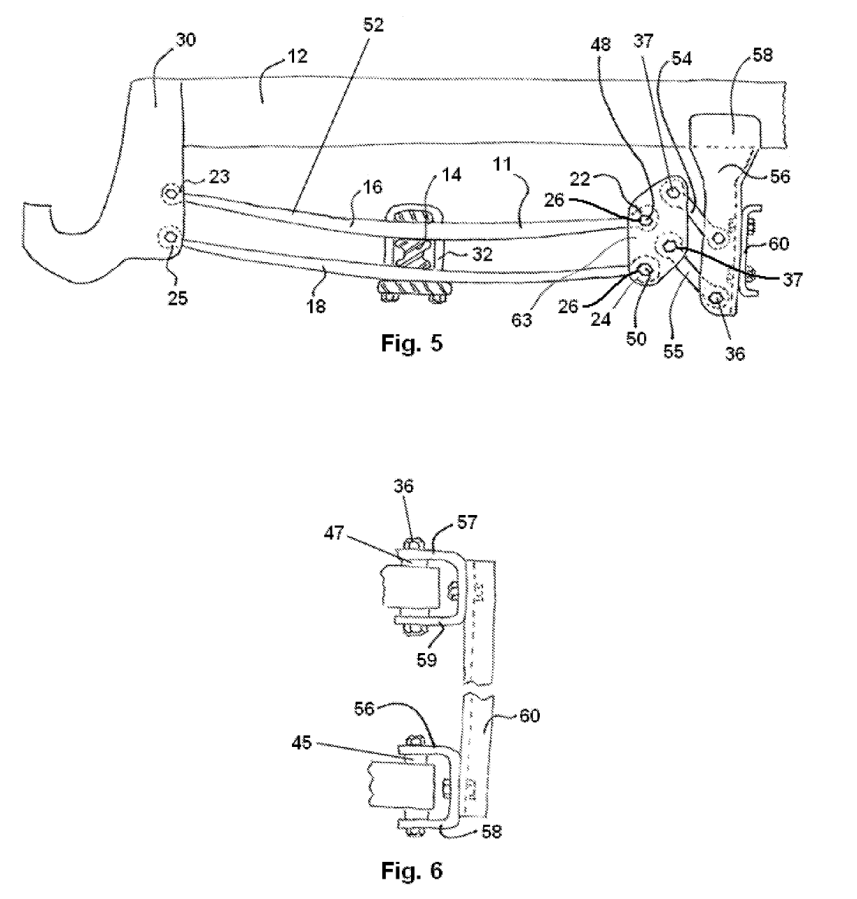

The embodiment of the suspension assembly 52 shown in FIGS. 5 and 6 has a shackle assembly 56 using a first tension shackle 54 and a second tension shackle 55 fastened to the first upper spring end 22 and first lower spring end 24 respectively. First tension shackle 54 and second tension shackle 55 pivotally fasten to shackle hanger 58. The first tension shackle 54 is located above the second tension shackle 55. Substantially parallel inner and outer load transfer plates 63 pivotally fasten to the first tension shackle 54 and second tension shackle 55 with shackle fasteners 37. Inner and outer load transfer plates 63 are pivotally fastened to the upper leaf spring 16 and to the lower leaf spring 18 with spring fasteners 26. A friction reducing device 45 such as a bushing 44 or a bearing 47 (not shown) may surround the shackle fasteners 37 or the spring fasteners 26. The inner and outer load transfer plates 63 may be polygonal and may have two pairs of opposite parallel sides, such as a parallelogram, and may have additional structures, such as holes, sculpted outer profile, flanges, reinforcing ribs, and the like, to improve weight and stiffness. A crossmember 60 may connect the shackle assembly 56 with a second shackle assembly 57 (not shown) located laterally on the opposite side of the chassis 12. The crossmember 60 may connect to the rear, bottom, or inside faces of the shackle hangers 58 and 59 of the shackle assemblies 56 and 57. Similarly, a crossmember 61 (not shown) may connect the first spring hanger 30 with a second spring hanger 31 (not shown) located laterally on the opposite side of the chassis 12.

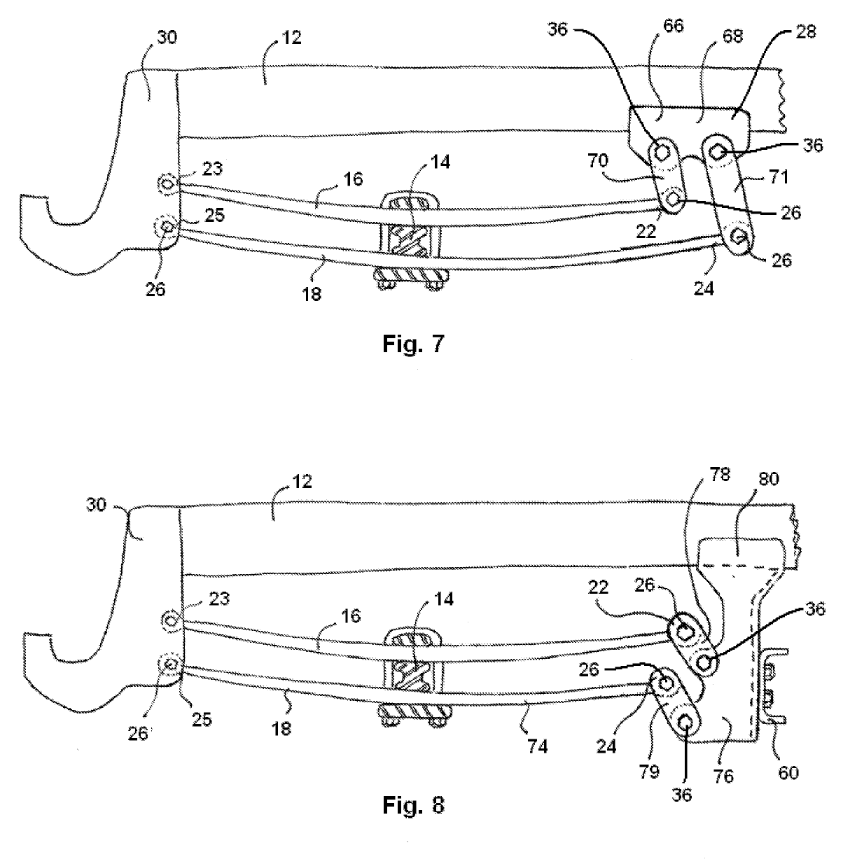

The embodiment of the suspension assembly 66 shown in FIG. 7 has a shackle assembly 68 with first compression shackle 70 and second compression shackle 71 pivotally fastened to the shackle hanger 28 with shackle fasteners 36. First compression shackle 70 and second compression shackle 71 pivotally fasten to the first upper spring end 22 and first lower spring end 24 respectively with spring fasteners 26.

In FIG. 8, the suspension assembly 74 has a shackle assembly 76 with first tension shackle 78 and second tension shackle 79 pivotally fastened to the shackle hanger 80 with shackle fasteners 36. First tension shackle 78 and second tension shackle 79 pivotally fasten to the first upper spring end 22 and first lower spring ends 24 with spring fasteners 26. The first tension shackle 78 is located above the second tension shackle 79. A crossmember 60 may connect the shackle hanger 80 of shackle assembly 76 to a similar hanger located laterally on the opposite side of the chassis 12.

Spring fasteners 26 and shackle fasteners 36 and 37 may be any type of fastener known in the art, such a fastener with a head 42 and a shank 43, or a pin. The spring fasteners 26 and shackle fasteners 36 and 37 may be surrounded by a friction reducing device 45 to reduce friction during movement. The friction reducing device 45 may be metal or may be at least partially elastomeric or polymeric. A bushing inner metal sleeve 90 may permit the first load transfer plate 38 and second load transfer plate 40 to be solidly clamped together by the spring fasteners 26 or shackle fasteners 36 or 37.

Other potential embodiments may include the axle 14 located either above (FIG. 9) or below (FIG. 10) the upper and lower leaf springs 16 and 18 instead of between the upper and lower leaf springs 16 and 18, with a spacer 84 located between the leaf springs 16 and 18. In addition, the upper leaf spring 16 may be comprised of multiple individual leafs, forming an upper leaf spring assembly 81, or the lower leaf spring 18 may be comprised of multiple individual leafs, forming a lower leaf spring assembly 82, or both the upper leaf spring 16 and the lower leaf spring 18 may be comprised of multiple individual leafs. The upper and lower leaf spring assemblies 81 and 82 may further be comprised of less than full leaf springs or half leaf springs connected to the upper or lower leaf spring assemblies 81 or 82 at the axle 14. More than two spaced apart leaf springs, such as leaf spring 83 in FIG. 10, may also be used in the suspension assembly, with spacers 84 located between the leaf springs 16, 18, and 83.

While specific embodiments have been described in detail in the foregoing detailed description and illustrated in the accompanying drawings, those with ordinary skill in the art will appreciate that various permutations are possible without departing from the teachings disclosed herein. Accordingly, the particular arrangements disclosed are meant to be illustrative only and not limiting as to the scope of the claims, which include all equivalents thereof. Other advantages to a Dual Load Path Suspension Assembly and a vehicle made with this assembly may also be inherent in the invention, without having been described above.

What is claimed is:

1. A suspension assembly for a vehicle having a chassis, comprising:
a first shackle assembly having a first shackle, a second shackle, and a shackle hanger attaching to the chassis and pivotally attaching to the first and second shackles;
an upper leaf spring assembly having a first upper spring end attached to the first shackle assembly, and an opposite second upper spring end;
a lower leaf spring assembly spaced apart from the upper leaf spring assembly and having a first lower spring end attached to the first shackle assembly spaced apart from the first upper spring end, and an opposite second lower spring end; and
an axle fastened to at least one of the leaf spring assemblies.

2. The suspension assembly for a vehicle having a chassis of claim 1, wherein:
the first upper spring end fastens to the first shackle of the first shackle assembly, and the first lower spring end fastens to the second shackle of the first shackle assembly.

3. The suspension assembly for a vehicle having a chassis of claim 2, wherein:
the second shackle is located behind the first shackle.

4. The suspension assembly for a vehicle having a chassis of claim 2, wherein:
the second shackle is located below the first shackle.

5. The suspension assembly for a vehicle having a chassis of claim 2, further comprising:
a second shackle assembly located laterally opposite to the first shackle assembly; and
a crossmember connecting the first shackle assembly and the second shackle assembly.

6. The suspension assembly for a vehicle having a chassis of claim 2, further comprising:
a first friction reducing device interposed between the first upper spring end and the first shackle of the first shackle assembly; and
a second friction reducing device interposed between the first lower spring end and the second shackle of the first shackle assembly.

7. The suspension assembly for a vehicle having a chassis of claim 1, further comprising:
a first spring hanger attaching to the chassis the second upper end of the upper leaf spring assembly attaching to the first spring hanger; and
the second lower end of the lower leaf spring assembly attaching to the first spring hanger.

8. The suspension assembly for a vehicle having a chassis of claim 7, wherein:
the second upper end of the upper leaf spring assembly is pivotally attached to the first spring hanger; and
the second lower end of the lower leaf spring assembly is pivotally attached to the first spring hanger.

9. The suspension assembly for a vehicle having a chassis of claim 7, wherein:
at least one of the second upper end of the upper leaf spring assembly and the second lower end of the lower leaf spring assembly is slidably attached to the first spring hanger.

10. The suspension assembly for a vehicle having a chassis of claim 7, further comprising:
a second spring hanger located laterally opposite to the first spring hanger; and
a crossmember connecting the first spring hanger and the second spring hanger.

11. The suspension assembly for a vehicle having a chassis of claim 7, further comprising:
a first friction reducing device interposed between the second upper end of the upper leaf spring assembly and the first spring hanger; and
a second friction reducing device interposed between the second lower end of the lower leaf spring assembly and the first spring hanger.

12. The suspension assembly for a vehicle having a chassis of claim 1, further comprising:
a load transfer assembly having an inner load transfer plate and an outer load transfer plate;
the first and second shackles being pivotally attached to the load transfer assembly;
the first upper spring end being attached to the load transfer assembly; and
the first lower spring end being attached to the load transfer assembly.

13. The suspension assembly for a vehicle having a chassis of claim 12, wherein:
the second shackle is located behind the first shackle.

14. The suspension assembly for a vehicle having a chassis of claim 12, wherein:
the second shackle is located below the first shackle.

15. The suspension assembly for a vehicle having a chassis of claim 12, further comprising:
a second shackle assembly located laterally opposite to the first shackle assembly; and
a crossmember connecting the first shackle assembly and the second shackle assembly.

16. The suspension assembly for a vehicle having a chassis of claim 12, wherein:
the first upper spring end is pivotally attached to the load transfer assembly; and
the first lower spring end is pivotally attached to the load transfer assembly.

17. The suspension assembly for a vehicle having a chassis of claim 12, wherein:
at least one of the first upper spring end and the first lower spring end is slidably attached to the load transfer assembly.

18. The suspension assembly for a vehicle having a chassis of claim 12, further comprising:
a first friction reducing device interposed between the first upper spring end and the load transfer assembly; and
a second friction reducing device interposed between the first lower spring end and the load transfer assembly.

19. The suspension assembly for a vehicle having a chassis of claim 12, further comprising:
at least one intermediate leaf spring assembly being located between and spaced apart from the upper leaf spring assembly and the lower leaf spring assembly;
the at least one intermediate leaf spring assembly having a first intermediate spring end attached to the load transfer assembly and having a second intermediate spring end.

20. A suspension assembly for a vehicle having a chassis, comprising:
a first spring hanger attached to the chassis;
a second spring hanger attached to the chassis;
an upper leaf spring assembly having a first upper spring end pivotally attached to the first spring hanger and a second upper spring end slidably attached to the second spring hanger;
a lower leaf spring assembly spaced apart from the upper leaf spring assembly and having a first lower spring end pivotally attached to the first spring hanger and having a second lower spring end slidably attached to the second spring hanger; and
an axle fastened to at least one of the leaf spring assemblies.
